(19) United States
(12) Patent Application Publication
(10) Pub. No.: US 2008/0055554 A1
(43) Pub. Date: Mar. 6, 2008

(54) Full Scale Plan Projection

(76) Inventors: Keith Tubin, Henderson, NV (US); Sylvia Kim, Las Vegas, NV (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/468,390

(22) Filed: Aug. 30, 2006

(51) Int. Cl. G03B 21/26

(52) U.S. Cl. 353/30

(57) ABSTRACT

A full scale plan projection system includes a processor and projector for displaying full scale building plans at a construction site or in a showroom to allow construction workers, clients, or prospective buyers to visualize completed projects. The full scale plan projection may be used by inspectors to compare as-built projects to the original approved plans. Electronic management of building plans reduces cost and risk of damage associated with paper drawings.

### BACKGROUND

Construction documents are tools used in all construction projects. Construction documents consist of, but are not limited to, site plans, landscaping and irrigation drawings, floor plans, reflected ceiling plans, finish plans, roof plans, structural drawings, MPE (mechanical, plumbing, electrical) drawings, elevations, schedules, details and written specifications. Some projects require only a few sheets of drawings. Larger more complicated projects require volumes and volumes of drawings and specifications.

Coordination of the different trades and the various elements and components shown and specified in the construction documents is crucial to any and all construction projects. However, as anyone who has been involved with construction can attest to, this is a very difficult task. Even the best laid plans and a well sequenced project will still have conflicts between trades and the different components will interfere with each other. These conflicts often result in costly change orders that not only impact money, but time as well, as often the work is required to be redone.

In addition, often as a condition of the contract, and always for the contractor's own documentation, record drawings need to be maintained and kept up during the course of construction. As-built conditions must be continually documented on record drawings to reflect field changes. This is a time consuming and a costly aspect of the construction process.

Moreover, record drawings must also reflect any changes or revisions that have been issued on the contract. New drawings and sheets are often issued to reflect changes and revisions to the work. It become imperative that superintendents and foreman make sure that the construction workers in the field are using the most current set of documents. Poor management of construction drawings and changes can lead to use of outdated drawings resulting errors and conflicts that are costly in terms of time, money, manpower and materials.

Over the course of construction, inspections are required to assure compliance with local building and life safety codes and ordinances. In addition to inspections by the Authority Having Jurisdiction (AHJ), many owners have additional inspection requirements as a means to monitor construction progress and adherence to the construction documents. During inspections, drawings and details are often referenced and viewed against the actual constructed elements to verify compliance. Already time consuming inspections can be drawn out into an even lengthier process, while contractors and inspectors struggle with often bulky and heavy rolls of drawings. Changes and revisions to the work may further complicate required inspections.

### SUMMARY

Construction documents can be scanned, stored digitally, and projected and scaled over the course of construction (from the foundations and stem walls to rough-in and framing, to sheathing and finishes) to alleviate and even eliminate many project and construction management issues.

For example, prior to the start of overhead rough-in installations of ductwork, conduits, plumbing and fire sprinkler piping, the reflected ceiling plan, the mechanical ductwork, the plumbing piping, the fire sprinkler piping and the electrical lighting drawings can be projected, in full scale onto the roof deck. Each trade maybe displayed in a different color and overlaid atop of each other. A coordination meeting can be held onsite with the owner, architect, contractor and relevant subcontractors to check for possible conflicts, discuss possible solutions, and decide the final direction.

Floor plans projected down onto the building/floor slab can be used to help framers lay out walls and doors. They can also be used to check locations of underslab and floor penetrations in relation to finished spaces and walls. On multiple story buildings, floor plan projections can be utilized to line up shaft penetrations and address any offsets in the floor plan, prior to concrete placement. Floor plan projections can also be utilized to discuss room layout and wall layout changes and help illustrate to the owner the impact of those changes, all before a single track is laid and a single stud is raised, saving time, labor and material.

Once wall framing is installed, elevation projections can be utilized to check locations and coordination of different components such as fenestrations, plumbing fixtures, casework, electrical devices and outlets, partitions, and architectural elements. This may help eliminate costly conflicts between, say a bank of electrical devices (outlets, switches) that will not fit between the king stud framing for a window and a door. The plumbing rough-in run for an in-counter sink can be checked against the location of an electrical panel. This would enable components such as electrical conduits and plumbing piping installations to be coordinated and any conflicts or changes addressed, prior to pulling wire through conduits and charging the pipe with water.

Using an added handheld controller/stylus pad device, field revisions and directed changes can be input onto the projected drawings as an overlay, which will can then be used to as-build the construction documents. In a similar manner, inspections can be streamlined and compliance easily demonstrated by projecting the relevant drawing (i.e. elevations, floor plans) onto the newly constructed frame.

Drawings and sketches of revisions and changes issued during the course of construction can be easily managed through the handheld device. Once digitally scanned, the drawing images can be uploaded onto the device and/or projector and displayed over framing, or decking, for example, to review and coordinate the impact of the changes, reducing the need to reconstructed elements as well as reducing the possibility of component conflicts.

### BRIEF DESCRIPTION OF THE DRAWINGS

FIG. 1 is a simplified and representative diagram of a full scale plan projection system;

FIG. 2 is a simplified and representative diagram of another embodiment of a full scale plan projection system;

FIG. 3 is a simplified and representative diagram of a full scale plan projection system used on a ceiling;

FIG. 4 is a simplified and representative diagram of a full scale plan projection system used to project a floor plan.

FIG. 5 is a simplified and representative diagram of a full scale plan projection system in use from a helicopter;

FIG. 6 illustrates plan scaling and keystone correction;

FIG. 7 illustrates a hardware associated with one method of plan scaling and keystone correction; and

FIG. 8 illustrates elements associated with one method of creating as-built drawings.

### DETAILED DESCRIPTION OF VARIOUS EMBODIMENTS

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

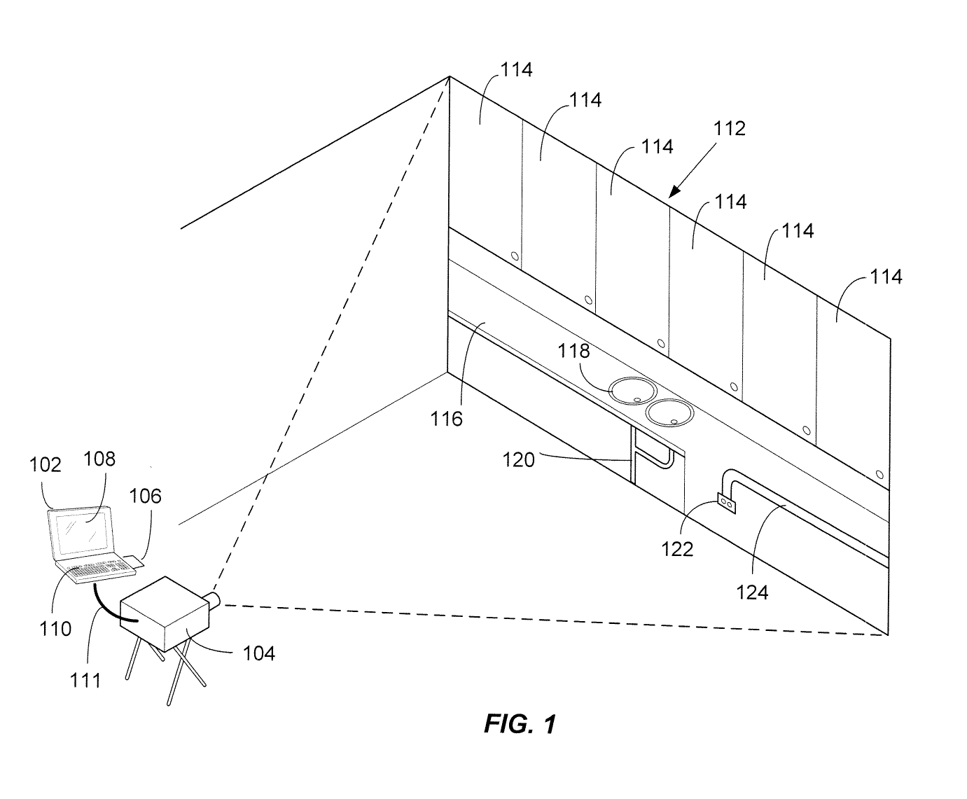

FIG. 1 illustrates a full-scale projection system 100. A processor 102 may be connected to a projector 104. The projector 104 may be or may be similar to a conventional computer projector already in common use. However, several of the embodiments described may require brightness over greater distances than is currently practical for current art projectors. In such cases, a projector using one or more lasers may be better suited for a particular environment. Multiple colored lasers, such as, red, green, and blue may help distinguish different elements or layers of the associated building plans. Alternately, different fill patterns may be used to distinguish between layers. The processor 102 may be a laptop computer, a personal digital assistant (PDA), a tablet computer, or a special function processor suitable to the task of storing and rendering building plans to the projector 104. The processor 102 may have a memory 106 for storing building plans. The memory 106 may be removably attached, for example, a thumb drive or flash drive, or may be embedded in the processor 102 as either fixed memory or a rotating storage system, known in the industry.

The memory may be kept current by downloading new or updated drawings. Such updates may even occur wirelessly using high speed cellular links or 802.11 wireless networks. The drawings may be generated on a computer-aided design (CAD) system, such as Autocad™. The projection system 100 is particularly useful when drawings are generated by different organizations associated with different crafts, such as mechanical and HVAC. Overlaying scanned images in the projection system may be a more effective way of determining interferences than trying to flip between pages of a construction drawing deck.

Appropriate document control and revision management may be incorporated in the download process, and may include digital signature verification to ensure that all involved parties have agreed to the change. Electronic management of drawings may actually improve the turnaround of updated drawings because manual signatures may be replaced by digital signatures, making it easier for remotely-located parties to review and sign off on changes. The processor 102 may include a display 108 and a keyboard 110, or equivalent data entry mechanism. A network connection 111, wired or wireless, may be used to couple the processor 102 to the projector 104.

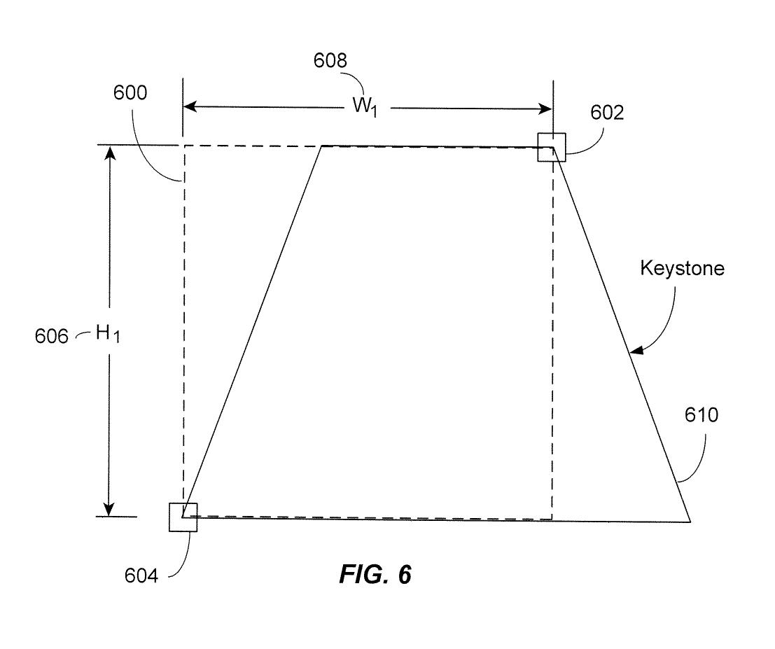

As depicted in FIG. 1, several elements, or layers, of building drawings may be projected on wall 112. The wall 112 may be new construction, an existing structure in the process of remodeling, or may be in a builder or architect's showroom. In this illustration, a full-scale projected image may include a series of cabinets 114, a countertop 116, a sink 118, drain pipes 120, an electrical outlet 122, and electrical conduit or wiring 124. The building plans, drawings, rough plans, etc. may be created and stored in a variety of formats. Computer-aided design (CAD) programs are available and in common use that allow creation of architectural plans, including Microsoft™ Visio. Projections may be made directly from the architectural program. Alternatively, an image or other representation may be rendered and stored, such as a JPEG or PDF file. Integration with scaling and markup capabilities may be native in the drawing program or may be offered as a add-on. Scaling and markup of the images are discussed more with respect to FIGS. 6-8 below.

The full-scale projection on wall 112 allows a contractor or client during a planning phase to visualize placement of various elements and confirm height and width of elements such as cabinets 114. During the construction phase, the projection allows construction workers to see the exact placement according to the building plans of the various elements, reducing or eliminating any confusion regarding various elements, for example, door swings or outlet locations. After completion of the construction, an inspector may use the projection to compare the as-built project to the inspector's set of approved drawings, that may also be stored electronically.

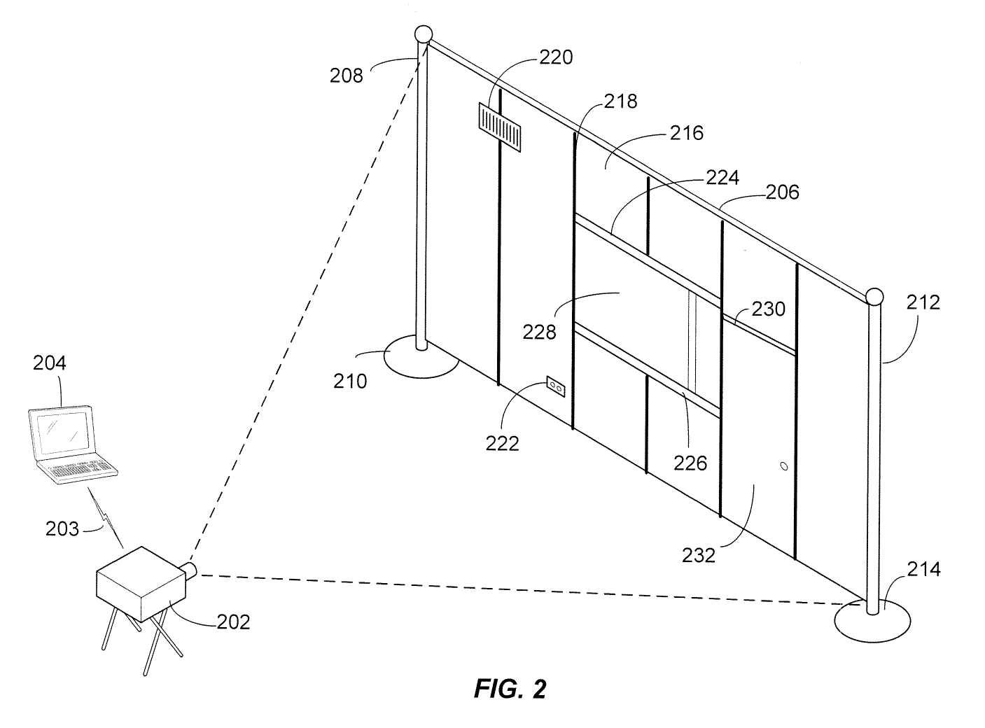

FIG. 2 illustrates another embodiment of a full-scale plan projection system. A processor 202 is shown wirelessly coupled 203 to a projector 204. A pole 208 is fixed to a base 210 and another pole 212 is fixed to another base 214. A connecting rod 206 may be used to hang a drop cloth or other material 216. The drop cloth 216 may be used as a target for projecting a full-scale image when no wall is available, for example, on a new construction site before framing the walls has been completed. In another embodiment, the drop cloth 216 may be used on a vacant lot to allow a prospective homebuilder to visualize access and window placements. When the drop cloth 216 is suitably thin, the projected image may be viewable from both sides of the drop cloth 216. The projection may be used to depict studs 218, a vent 220, an outlet 222, window headers 224 226, a window 228, a door header 230 and a door 232. And another embodiment, the drop cloth 216 may be replaced by any other mechanism for creating an opaque or translucent barrier, such as a mist or fog device.

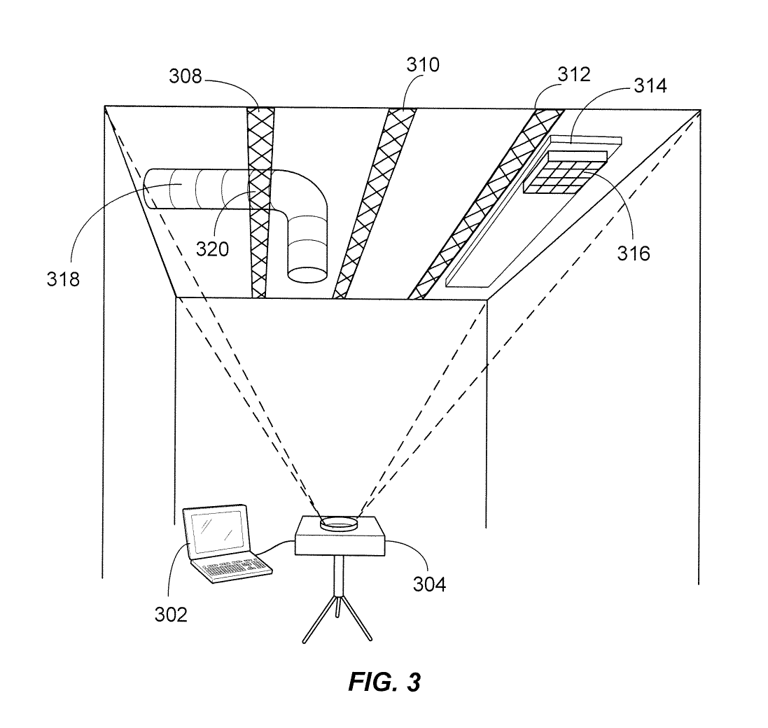

FIG. 3 depicts a full-scale plan projection system directed upward to a ceiling. Projector 302 may be coupled to a processor 304 to project on a target 306. As in the embodiments above, the target 306 may be actual construction, a showroom, or a virtual wall. This illustration depicts girders 308 310 312, HVAC duct work 314, and vent 316. Also, from perhaps another layer, a pipe 318 is shown. By combining layers that include girders and piping it is easy to see that an interference exists between the pipe 318 and the girder 308 at point 320. By identifying interferences early in the planning stages, it is relatively inexpensive to make adjustments to the plans compared with making such changes during construction in the field. In one embodiment, any of the depicted elements may be actual constructions, for example, the girders 308 310 312 may be physically present. When working with build-to-requirements elements, such as fire sprinklers, the location of sprinkle piping may be present before other crafts have completed work, such as ducts. By projecting duct work onto the existing sprinkler piping, interferences are easily identified and accounted for, before actual work begins, saving both time and money.

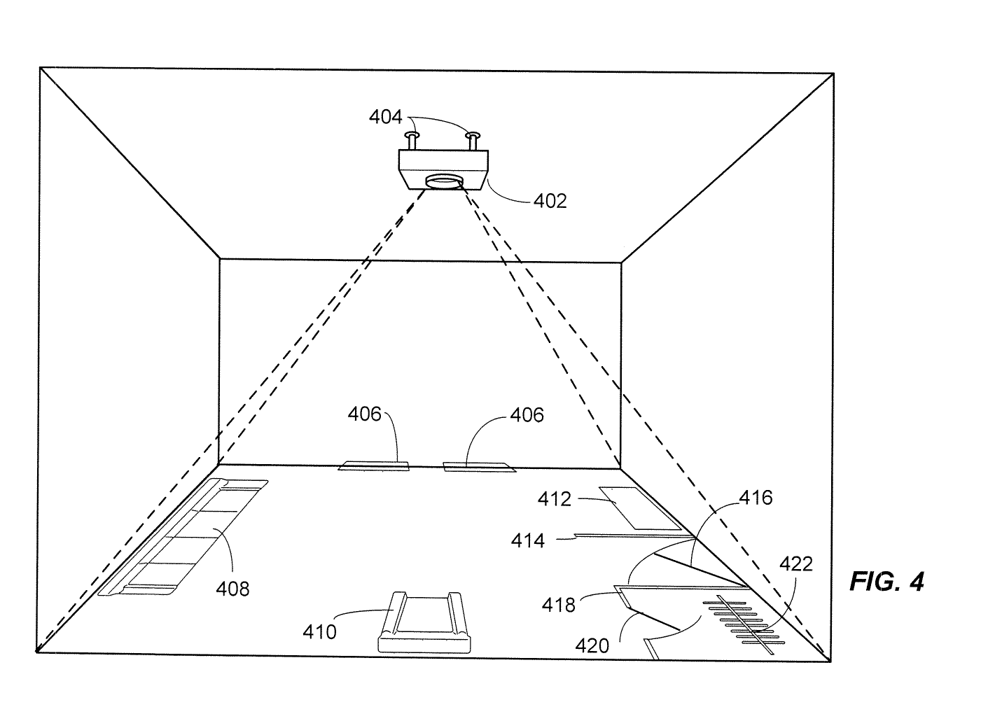

FIG. 4 depicts another use of full-scale plan projection. A projector 402 may be coupled to a ceiling using mounts 404 and networked to a remote processor (not depicted). Full-scale floor plans may be projected on the floor for use in planning not only construction features such as windows 406, walls 412 418, doors 414 420, and closet bar 422, but also decorating items such as a couch 408, a chair 410 and a television 412. The fixed elements such as walls and doors may depict existing features in a home or office when used for planning interior decorating. The fixed elements may be used for interactive placement of both construction features and as well as decorating items when planning new construction.

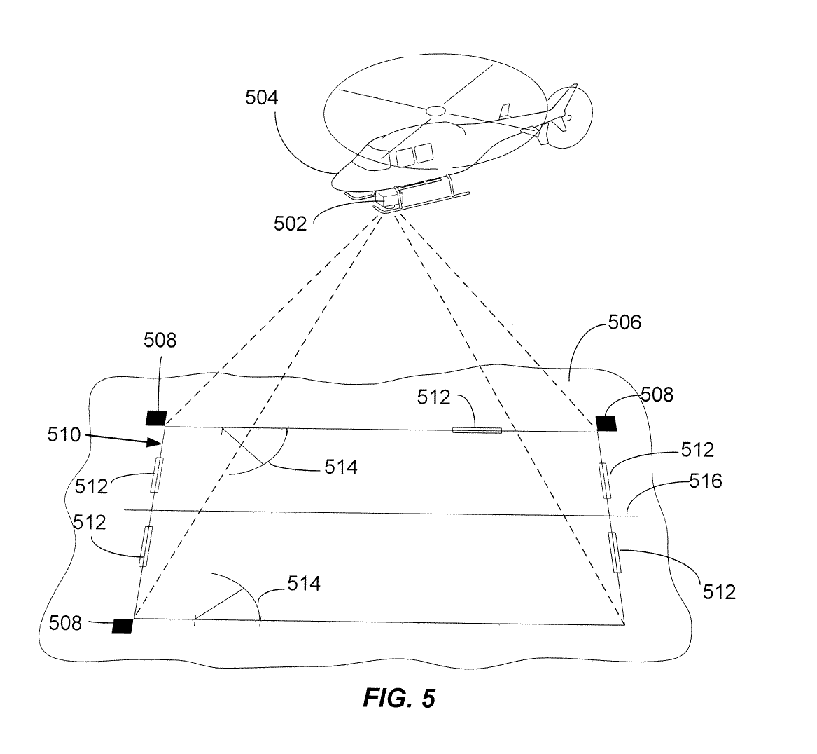

FIG. 5 depicts another use of full-scale plan projection on a large scale. A projection system 502 may be mounted on a helicopter 504, or other device capable of providing suitable height, such as a crane or boom. An area of undeveloped ground 506 may be used as a target for projection. Alignment marks 508 may be used to indicate survey points and may be used by an operator or automated mechanism for aligning the projected image to the desired spot on the ground 506. In this illustration, an outline of a house 510 is depicted showing windows 512, doors 514, and roof ridge line 516. Such a projection may be invaluable in allowing a prospective homebuilder to visualize sight lines and access points. The projection may also be useful in identifying clearance issues, for example, with nearby trees or rock outcroppings.

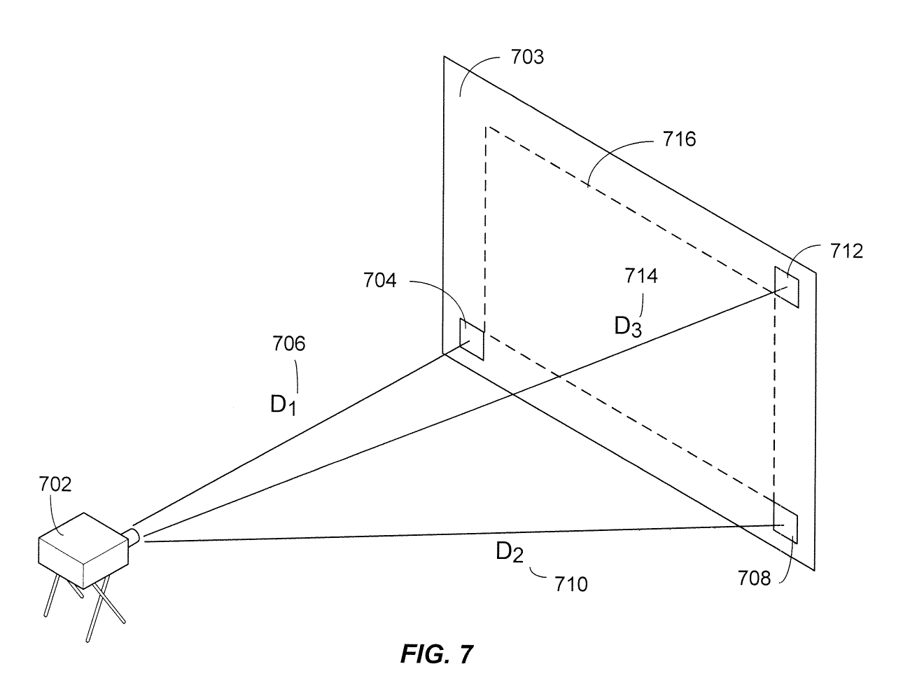

FIG. 6 illustrates a method of scaling a projected image to correct dimensions. A projected image may be relatively easy to scale in a controlled environment, such as, on an actual wall under construction. However, in other environments, such as a showroom, the exact wall dimensions must be easily discernible in order to correctly project the full-scale image. FIG. 6 shows an image 600 projected on a surface. Alignment marks 602 and 604 may be placed a measured distance apart corresponding to the actual environment, with a given height 606 and width 608. The alignment marks may be temporarily attached to the target surface using light adhesive, double-faced tape or fasteners, depending on the type and finish of the target. When the projector location can be closely fixed, the projected image 600 may be suitably rectangular and even. However, in many environments the projector may be above or below a centerline and right or left of the midpoint corresponding to the target surface. This may result in an effect known as a keystone, depicted by quadrilateral 610. A method of addressing keystoning is described with respect to FIG. 7.

FIG. 7 illustrates hardware associated with a method of correcting for scaling and keystoning of a full-scale plan projection. A projector 702 may be coupled to a processor (not depicted) and located a distance away from a target surface 703. An alignment mark 704 may be a distance D1 (706) from the projector 702, an alignment mark 708 may be a distance D2 (710) from the projector 702, and an alignment mark 712 may be a distance D3 (714) from the projector 702.

In one embodiment, the projection may be manually adjusted for keystone and scale so that the corners of the image match each respective corner alignment marks 704 708 712. In another embodiment, the projector 702 may be able to determine the distance to each alignment mark by scanning each corner 704 708 712 using a light source in the projector, for example, a laser and reflected light from each respective alignment mark. Because three points define a plane, the horizontal and vertical offset from a center point may be easily calculated using distances D1, D2, and D3. A fourth corner of the image may be determined through a simple trigonometric calculation, or in another embodiment, the fourth corner may have an explicit alignment mark. When the four corners of the full-scale plan projection are defined, relatively simple adjustments to scale and the keystone the image may be calculated and the image displayed.

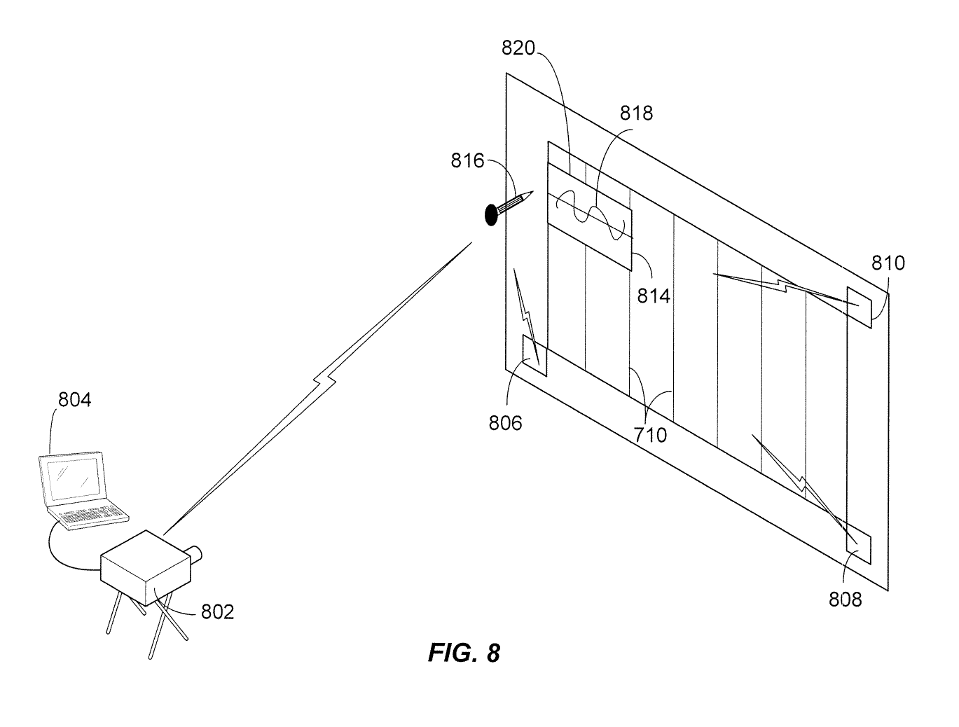

FIG. 8 illustrates another embodiment for managing full-scale image projection. A projector 802 and a processor 804 may be coupled either wirelessly or by a wired network connection. Alignment marks 806 808 810 may be placed at the corners of the full-scale projection as described in FIG. 7. In the embodiment illustrated, the alignment marks 806 808 810 may be active, emitting coded signals using either optical signals, such as infrared, or ultrasound signals for determining distance from the projector 802. The coding may correspond to the each particular alignment mark, such as, bottom right. The full-scale projection illustrated shows wall studs 812 and an initial window opening 814. A pointer 816 may be used to update changes to the full-scale projection either during the planning phases or for creating an as-built diagram. The pointer 816 may use the coded signals from the alignment marks 806 808 812 and forward either raw position data or a calculated position, relative to the alignment marks, back to the processor 804. The processor 804 may generate new projection lines, such as line 818 indicating removal of an element and new line 820 indicating increased size of the window opening 814. The added lines may be overlayed or otherwise incorporated with the projected image to create a marked-up version in real time. Technology for tracking marker movement on a whiteboard is available from companies such as Virtual Ink™. Alternatively, markups may be input using a standard drawing package, such as Visio™, on a computer and input device supporting the associated drawing projection.

The ability to digitally store and project construction drawings at full scale presents benefits to builders, their current customers, and their prospective customers. Multiple layers of drawings may be easily overlaid to allow checking for interferences. Full-sized visualizations of floor plans, wall and cabinet layouts, as well as window and door placements allows both better planning and more accurate construction. Cost savings may be realized over printing and management of paper drawings while additional cost savings may be realized by real-time on-site creation of as-built revisions to original drawings. Building inspectors can quickly and easily compare actual construction to approved drawings. When projected on suitable target surfaces, full scale plan projections may be viewed from both sides of the target, allowing, for example, a prospective homebuyer to view full sized elevations from the street as well as from the interior. Lot-sized vertical projections allow homebuyers to “walk the house” and get a first-hand idea of sight lines and home placement with respect to lot lines. The use of alignment marks may supplement or replace manual adjustment of the projection, making overall operation simpler and more accurate.

Although the forgoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

We claim:

1. A projection system comprising:
a memory storing a first element of a building plan;
a processor coupled to the first memory;
a projector coupled to the processor; and
a display coupled to the processor implementing a user interface for managing projection by the projector of a full-scale image of the first element of the building plan on a target.

2. The projection system of claim 1, wherein the target comprises a wall, a floor, or a ceiling of a building associated with the building plan.

3. The projection system of claim 2, wherein the target further comprises at least one existing construction elements.

4. The projection system of claim 3, wherein the plurality of construction elements comprises at least one of piping, ducts, framing, trusses, and wiring.

5. The projection systems of claims 1, wherein the target is ground, a drop cloth, ground, and a smoke curtain.

6. The projection system of claim 1, wherein the target is completed construction.

7. The projection system of claim 1, further comprising:
a ranging device for determining distance to the target for use in adjusting the dimensions of the full-scale image of the building plans.

8. The projection system of claim 3, further comprising an alignment mark for use by the ranging device in adjusting the dimensions of the full-scale image of the building plans.

9. The projection system of claim 5, wherein the alignment mark is one of a reflector, an acoustic source, and an optical source.

10. The projection system of claim 1, wherein the user interface supports manual entry of alignment mark coordinates for use in scaling the full-scale image to the target.

11. The projection system of claim 1, wherein the memory stores a second element of the building plan and the projector presents a full-scale image of the second element of the building plan in alignment with the full-scale image of the first element of the building plan.

12. The projection system of claim 11, wherein the full-scale image of the second element of the building plan is presented in a different color from the full-scale image of the first element of the building plan.

13. The projection system of claim 1, further comprising a data entry device for entry of drawing information corresponding to as-built construction.

14. The projection system of claim 1, further comprising a data entry device for entry of notes corresponding to differences between as-built construction and the projection of the full-scale image of the first element of the building plan.

15. The projection system of claim 1, wherein the first element of the building plan is one of a wall plan, HVAC piping, electrical routing, plumbing, trusses, furniture, cabinetry, and appliances.

16. The projection system of claim 1, wherein the projector is one of a laser projector and a computer display projector.

17. A method of managing construction drawings on a job site comprising:
storing a first construction drawing on a computer-readable medium;
displaying an image of the first construction drawing on a target corresponding to an actual or proposed location for items represented in the first construction drawing; and
adjusting the image to present a full-scale representation of the first construction drawing on the target.

18. The method of claim 18, further comprising making changes to the first construction drawing corresponding to differences between the image of the first construction drawing displayed on the target and a desired version of the construction drawing.

19. The method of claim 18, further comprising:
storing a second construction drawing on the computer-readable medium;
displaying a second image corresponding to the second construction drawing in a location corresponding to the actual or proposed location for items represented in the second construction drawing;
adjusting the second image to present a full-scale representation of the second construction drawing overlaying the image of the first construction drawing.

20. The method of claim 20, wherein displaying the second image comprises displaying the second image in contrast to the first image to allow distinguishing between the first image and the second image.

21. The method of claim 20, further comprising entering data that is reflected on at least one of the first and second construction drawings.

22. A method of displaying images for use in construction comprising:
storing construction data;
projecting an image corresponding to the construction data;
determining alignment of the image to a target location; and
adjusting the image to render a full-scale image corresponding to the construction data on the target location.

23. The method of claim 22, wherein determining alignment of the image to the target location comprises determining at least one distance to the target location and adjusting the image size according to the at least one distance.

24. The method of claim 22, wherein projecting the image corresponding to the construction data comprises projecting a plurality of images corresponding to the construction data.

25. The method of claim 2, further comprising capturing mark-up data using an input device and storing the mark-up data with the construction data.
